(19) United States
(12) Patent Application Publication
(10) Pub. No.: US 2025/0202134 A1
(43) Pub. Date: Jun. 19, 2025

(54) ANTENNA DEVICE

(71) Applicant: TOHOKU UNIVERSITY, Sendai-shi, Miyagi (JP)

(72) Inventors: Chen QIANG, Sendai-shi (JP); Junyi XU, Sendai-shi (JP)

(73) Assignee: TOHOKU UNIVERSITY, Sendai-shi, Miyagi (JP)

(21) Appl. No.: 18/847,375

(22) PCT Filed: Dec. 26, 2022
(86) PCT No.: PCT/JP2022/047865

§ 371 Date: Sep. 16, 2024

(30) Foreign Application Priority Data
Mar. 18, 2022 (WO) PCT/JP2022/012896

(51) Int. Cl. H01Q 25/00; H01Q 19/24; H01Q 21/20

(52) U.S. Cl. CPC H01Q 25/001; H01Q 19/24; H01Q 21/205

(57) ABSTRACT

A ground component is made of a columnar or cylindrical conductor and is connected to a ground potential. A cover component is cylindrical and made of a material containing dielectrics. The cover component is arranged at a distance from the ground component so as to cover the outer surface of the ground component, with the ground component inserted therein. The antenna element is arranged between the inner surface of the cover component and the outer surface of the ground component.

### FIELD OF THE INVENTION

The present invention relates to an antenna device.

### DESCRIPTION OF RELATED ART

In general, in an antenna device used in a base station of a mobile communication system, omnidirectional property in the horizontal plane and high gain are required to support the transmission and reception of radio waves in all directions. Conventionally, in base stations and the like, a circular arrangement of a plurality of antenna elements has been widely used to achieve omnidirectional property in the horizontal plane. In addition, in order to improve gain, some circularly arranged antenna elements have been formed into an array (see, for example, Patent Literature 1).

Note that, conventionally, it has been known that in a planar structure which is made up of a first layer with one surface grounded and a dipole antenna arranged therein, and a second layer laminated on the other surface of the first layer, and in which one side of the second layer opposite the first layer is free space, and the first layer and the second layer have different relative permittivity and magnetic permeability, it is possible to improve gain under certain conditions (see, for example, Non-Patent Literature 1).

### CITATION LIST

### Patent Literature

Patent Literature 1: JP 2006-74473 A

### Non-Patent Literature

Non-Patent Literature 1: David R. Jackson and N. G. Alexopoulos. “Gain Enhancement Methods for Printed Circuit Antennas”, IEEE transactions on antennas and propagation, September 1985, Vol. AP-33, No. 9, p. 976-987

### SUMMARY OF THE INVENTION

In an antenna device in which a plurality of antenna elements are arranged in a circle, as described in Patent Literature 1, arraying a plurality of antenna elements can improve not only omnidirectional property in the horizontal plane but also the gain. However, in order to improve the gain, it is necessary to increase the number of antenna elements, which increases the material costs.

The present invention has been made with a focus on these problems and aims to provide an antenna device that can improve gain with fewer antenna elements and reduce material costs.

### Means for Solving the Problems

In order to achieve the above object, the inventors of the present invention conducted extensive research based on the knowledge that the planar structure described in Non-Patent Literature 1 can provide gain improvement effects and found that by expanding the planar structure to a columnar structure and adjusting various conditions, omnidirectional property and gain improvement effects in the horizontal plane could be obtained, leading to the present invention.

That is, an antenna device according to the present invention includes a ground component made of a columnar or cylindrical conductor and connected to a ground potential; a cover component made of a material containing dielectrics, having a cylindrical shape, into which the ground component is inserted, the cover component being arranged at a distance from the ground component so as to cover an outer surface of the ground component; and an antenna element arranged between an inner surface of the cover component and the outer surface of the ground component.

The antenna device according to the present invention can improve the gain by arranging the antenna element between the inner surface of the cover component made of a material containing dielectrics and the outer surface of the ground component connected to a ground potential and covering it with the cover component. This allows the number of antenna elements to be reduced compared to a case in which a plurality of antenna elements are arranged in a circle to obtain the same gain improvement effect. In this way, the antenna device according to the present invention can improve the gain with fewer antenna elements. In addition, by using a cover component that is less expensive than the antenna elements, the material costs of the antenna elements, the antenna feeding circuit, and the like can be reduced.

The cover component may be made of any material that contains dielectrics and has a relative permittivity greater than 1. It is particularly preferable that the cover component be made of one type of dielectrics and have a relative permittivity of 2 to 8. The antenna element may be any material, but since it is arranged between the inner surface of the cover component and the outer surface of the ground component, it is preferable that it is made of a linear antenna such as a monopole antenna or a dipole antenna, or a thin antenna such as a crossed-dipole antenna.

In the antenna device according to the present invention, it is preferable that the antenna element is made up of a plurality of antenna elements which are arranged at equal angular intervals around a central axis of the ground component. In this case, by adjusting the number of antenna elements according to the beam width of the antenna elements, excellent omnidirectional property in the horizontal plane can be achieved. It is particularly preferable that the number of antenna elements is three or more.

The antenna device according to the present invention may also include an element group made up of a plurality of antenna elements, in which the antenna elements are arranged at equal angular intervals around a central axis of the ground component, wherein the element group may be made up of a plurality of element groups which are arranged side by side at predetermined intervals along the central axis of the ground component. In this case as well, excellent omnidirectional property in the horizontal plane can be realized by adjusting the number of antenna elements in each element group according to the beam width of the antenna elements. Furthermore, by using a plurality of element groups, it is possible to improve the gain compared to when there is only one element group.

In addition, when the antenna device has a plurality of element groups, the antenna elements of each element group may be arranged at the same position in the circumferential direction of the central axis of the ground component. However, it is preferable that each antenna element of each element group is arranged at a shifted position around the central axis of the ground component with respect to a position of each antenna element of an adjacent element group. In this way, it is possible to realize even better omnidirectional property in the horizontal plane.

In the antenna device according to the present invention, it is preferable that the cover component is arranged coaxially with the ground component, and m×0.4×λ₀≤a≤m×0.6×λ₀ (where m=1, 2, 3, and so on) is satisfied where λ₀ is the wavelength of a used frequency in free space, and a is a distance between the inner surface of the cover component and the outer surface of the ground component. In this case, the gain improvement effect can be further improved.

In the antenna device according to the present invention, it is preferable that each antenna element is arranged within a range of (2n−4/3)×λ₀/4 to (2n−2/3)×λ₀/4 (where n=1, 2, 3, and so on) from the outer surface of the ground component. In this case, the gain improvement effect can be further improved.

In the antenna device according to the present invention, it is preferable that a thickness t of the cover component is (2q−4/3)×λg/4≤t≤(2q−2/3)×λg/4 (where q=1, 2, 3, and so on) where λg is the wavelength of a used frequency in the cover component. In this case, the gain improvement effect can be further enhanced.

According to the present invention, it is possible to provide an antenna device that can improve gain with fewer antenna elements and reduce material costs.

### BRIEF DESCRIPTION OF THE DRAWINGS

FIG. 1(a) is a cross-sectional view and FIG. 1(b) is a perspective view of an antenna device according to an embodiment of the present invention.

FIG. 2(a) is a cross-sectional view and FIG. 2(b) is a perspective view of a modified example of an antenna device according to an embodiment of the present invention, in which a plurality of antenna elements are used.

FIG. 3 shows a modified example of an antenna device according to an embodiment of the present invention when there is a plurality of element groups, in which FIG. 3(a) is a perspective view showing a modified example with four element groups, FIG. 3(b) is a perspective view showing a modified example with six element groups, FIG. 3(c) is a plan view showing three antenna elements of each element group arranged at the same position in the circumferential direction of the central axis of a ground component, and FIG. 3(d) is a plan view showing three antenna elements of adjacent element groups rotated 60 degrees around the central axis of the ground component.

FIGS. 4(a), 4(b), and 4(c) show graphs showing the directivity of horizontally polarized waves E, and vertically polarized waves E_{θ} in the xy plane (horizontal plane), the xz plane (vertical plane), and the yz plane (vertical plane) of the antenna device shown in FIG. 1, respectively.

FIGS. 5(a), 5(b), and 5(c) show graphs showing the directivity of horizontally polarized waves E, and vertically polarized waves E_{θ} in the xy plane (horizontal plane), the xz plane (vertical plane), and the yz plane (vertical plane) of a comparative example without a cover component for the antenna device shown in FIG. 1, respectively.

FIG. 6 is a graph showing the change in maximum gain (Gain) of vertically polarized waves E_{θ} in the xy plane (horizontal plane) with respect to the thickness t of the cover component of the antenna device shown in FIG. 1.

FIG. 7 is a graph showing the change in maximum gain (Gain) of vertically polarized waves E_{θ} in the xy plane (horizontal plane) with respect to the radius d₃ of the ground component of the antenna device shown in FIG. 1.

FIGS. 8(a), 8(b), and 8(c) are graphs showing the directivity of horizontally polarized waves E, and vertically polarized waves E_{θ} in the xy plane (horizontal plane), the xz plane (vertical plane), and the yz plane (vertical plane) of the antenna device shown in FIG. 2, respectively.

FIGS. 9(a), 9(b), and 9(c) are graphs showing the directivity of horizontally polarized waves E, and vertically polarized waves E_{θ} in the xy plane (horizontal plane), the xz plane (vertical plane), and the yz plane (vertical plane) of a comparative example without a cover component for the antenna device shown in FIG. 2, respectively.

FIG. 10(a) is a plan view and FIG. 10(b) is a perspective view of an antenna device according to an embodiment of the present invention when there are two element groups and the positions of three antenna elements of adjacent element groups are rotated 60 degrees around the central axis of the ground component.

FIG. 11(a) is a plan view and FIG. 11(b) is a perspective view of an antenna device according to an embodiment of the present invention when there are two element groups and the three antenna elements of each element group are arranged at the same position in the circumferential direction of the central axis of the ground component.

FIGS. 12(a) and 12(b) are graphs showing the directivity of horizontally polarized waves E, and vertically polarized waves E_{θ} in the xy plane (horizontal plane) of the antenna device shown in FIG. 10 and the antenna device shown in FIG. 11, respectively.

FIGS. 13(a) and 13(b) are graphs, respectively, showing the change in the magnitude of deviation (roundness) of the gain of vertically polarized waves E_{θ} from a circular shape and the average gain with respect to the number of element groups for the antenna devices shown in FIGS. 3(a), 3(b), and 3(d).

FIGS. 14(a) and 14(b) are graphs, respectively, showing the change in magnitude of deviation (roundness) of the gain of vertically polarized waves E_{θ} from a circular shape and the average gain with respect to the interval h between the element groups of the antenna devices shown in FIGS. 3(a), 3(b), and 3(d).

### DETAILED DESCRIPTION OF THE INVENTION

Hereinafter, an embodiment of the present invention will be described with reference to the drawings.

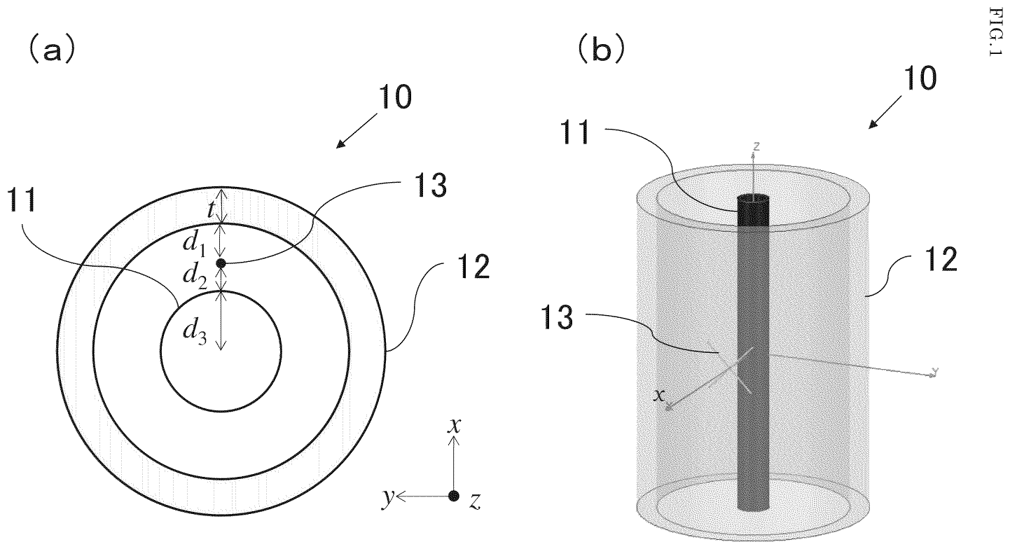

FIGS. 1 to 14 show an antenna device according to an embodiment of the present invention.

As shown in FIG. 1, an antenna device 10 has a ground component 11, a cover component 12, and an antenna element 13.

The ground component 11 is made of a columnar conductor and is connected to a ground potential. The ground component 11 may be made of any material, such as aluminum, as long as the outer surface can be set to a ground potential. The ground component 11 may be cylindrical.

The cover component 12 is cylindrical, with an inner diameter larger than the outer diameter of the ground component 11. The cover component 12 is made of a material containing dielectrics, and the ground component 11 is inserted inside. The cover component 12 is arranged coaxially with the ground component 11 at a distance from the ground component 11 so as to cover the outer surface of the ground component 11. In a specific example shown in FIG. 1, the cover component 12 is made of FR4 (Flame Retardant Type 4) and has a relative permittivity of 4.3 to 5.0. The cover component 12 may be made of any material as long as its relative permittivity is greater than 1, but it is particularly preferable that the cover component 12 is made of one type of dielectrics and has a relative permittivity of 2 to 8.

The antenna element 13 is arranged between the inner surface of the cover component 12 and the outer surface of the ground component 11. In a specific example shown in FIG. 1, the antenna element 13 is made of a crossed-dipole antenna and is arranged so that its thickness direction is along the radial direction of the ground component 11 and the cover component 12. The antenna element 13 may be a linear element such as a monopole antenna or a dipole antenna, in which case it is preferable that the extension direction is parallel to the central axis of the ground component 11 and the cover component 12.

As shown in FIG. 1(a), in one specific example of the antenna device 10, t=λg/4, d₁=λ₀/4, d₂=λ₀/4, and a=d₁+d₂=λ₀/2, where t is the thickness of the cover component 12, a is the distance between the inner surface of the cover component 12 and the outer surface of the ground component 11, d₁ is the distance from the inner surface of the cover component 12 to the antenna element 13, d₂ is the distance from the antenna element 13 to the outer surface of the ground component 11, d₃ is the radius of the ground component 11, 2% is the wavelength of the frequency used in free space, and λg is the wavelength of the frequency used in the cover component 12. In addition, equivalent performance may be obtained in the ranges where λ₀/4−λ₀/10≤d₁≤λ₀/4+λ₀/10, λ₀/4−λ₀/10≤d₂≤λ₀/4+λ₀/10, and λ₀/2−λ₀/10≤a≤λ₀/2+λ₀/10.

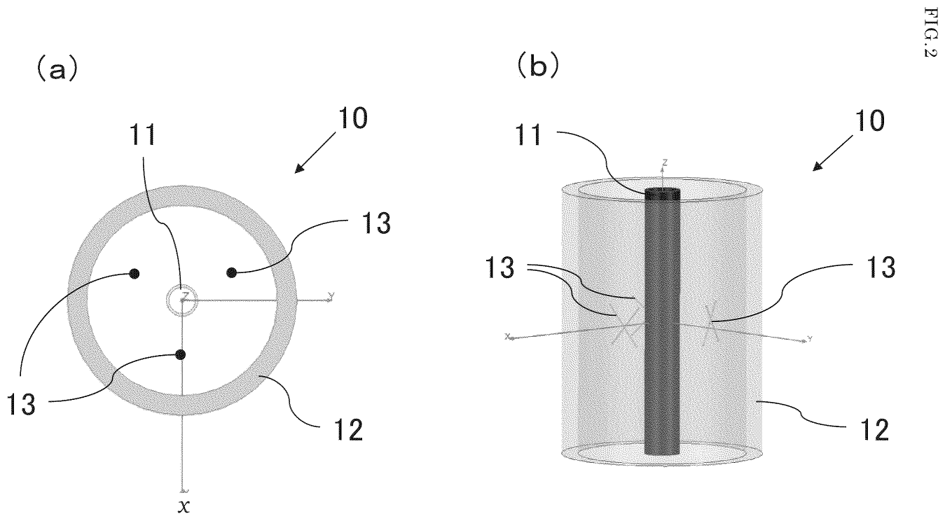

As shown in FIG. 2, the antenna device 10 may be composed of a plurality of antenna elements 13 arranged at equal angular intervals around the central axis of the ground component 11. In the specific example shown in FIG. 2, there are three antenna elements 13, but four or more antenna elements may be used. In this case, excellent omnidirectional property in the horizontal plane can be achieved by adjusting the number of antenna elements 13 according to the beam width of the antenna elements 13. It is preferable that the antenna elements 13 are arranged at the same position in the extension direction of the central axis of the ground component 11, but if the magnitude of deviation (roundness) of the gain from a circular shape in the horizontal plane deteriorates, the antenna elements 13 may be arranged at a position shifted along the central axis of the ground component 11 to improve the roundness.

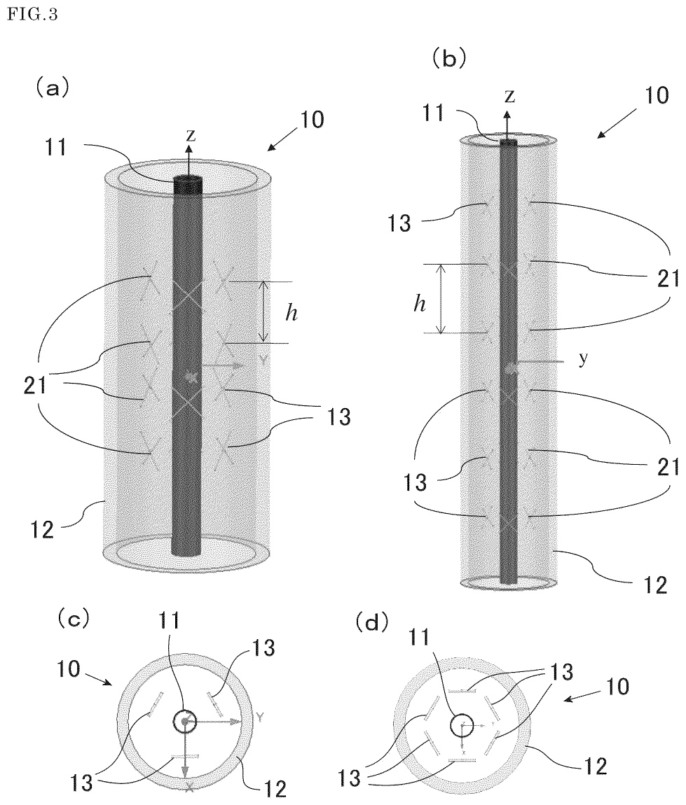

In addition, as shown in FIG. 3, the antenna device 10 has an element group 21 made up of a plurality of antenna elements 13, in which the antenna elements 13 are arranged at equal angular intervals around the central axis of the ground component 11, and the element group 21 may be composed of a plurality of element groups which are arranged side by side at predetermined intervals h along the central axis of the ground component 11. In a specific example, there are four element groups 21 in FIG. 3(a) and six element groups in FIG. 3(b), but there may be two, three, five, or seven or more element groups 21. In addition, the number of antenna elements 13 in each element group 21 may be any number as long as it is more than one, but it is particularly preferable that the number is three or more. In addition, the number of antenna elements 13 may differ for each element group 21. In this case as well, by adjusting the number of antenna elements 13 in each element group 21 according to the beam width of the antenna element 13, excellent omnidirectional property in the horizontal plane can be realized. In addition, by using a plurality of element groups 21, the gain can be improved compared to when there is only one element group 21. It is preferable that the antenna elements 13 of each element group 21 are arranged at the same position in the extension direction of the central axis of the ground component 11.

As shown in FIG. 3(c), the antenna elements 13 of each element group 21 may be arranged at the same position in the circumferential direction of the central axis of the ground component 11. However, if the magnitude of deviation (roundness) of the gain from the circular shape in the horizontal plane deteriorates, the antenna elements 13 may be arranged at a shifted position around the central axis of the ground component 11 as shown in FIG. 3(d) in order to improve the roundness. In FIGS. 3(a), 3(b) and 3(d), the positions of the antenna elements 13 of adjacent element groups 21 are shifted by rotating them by 60 degrees around the central axis of the ground component 11 in order to improve the roundness.

Next, the operation will be described.

The antenna device 10 can improve the gain by arranging the antenna elements 13 between the inner surface of the cover component 12 made of a material containing dielectrics and the outer surface of the ground component 11 connected to the ground potential and covering it with the cover component 12. This allows the number of antenna elements 13 to be reduced compared to a case in which a plurality of antenna elements 13 are arranged in a circle to obtain the same gain improvement effect. In this way, the antenna device 10 can improve the gain with fewer antenna elements 13. In addition, by using the cover component 12, which is less expensive than the antenna elements 13, the material costs can be reduced.

### Example 1

For the antenna device 10 shown in FIG. 1, the directivity in the horizontal and vertical planes, as well as the relationship between the thickness t of the cover component 12 and the radius d₃ of the ground component 11 and the gain were obtained. Here, the frequency used was 5 GHZ, the radius of the ground component 11 was d₃=120 mm, and the relative permittivity of the cover component 12 was 4.4. As a result, λ₀=60 mm, and λg≈28.6 mm.

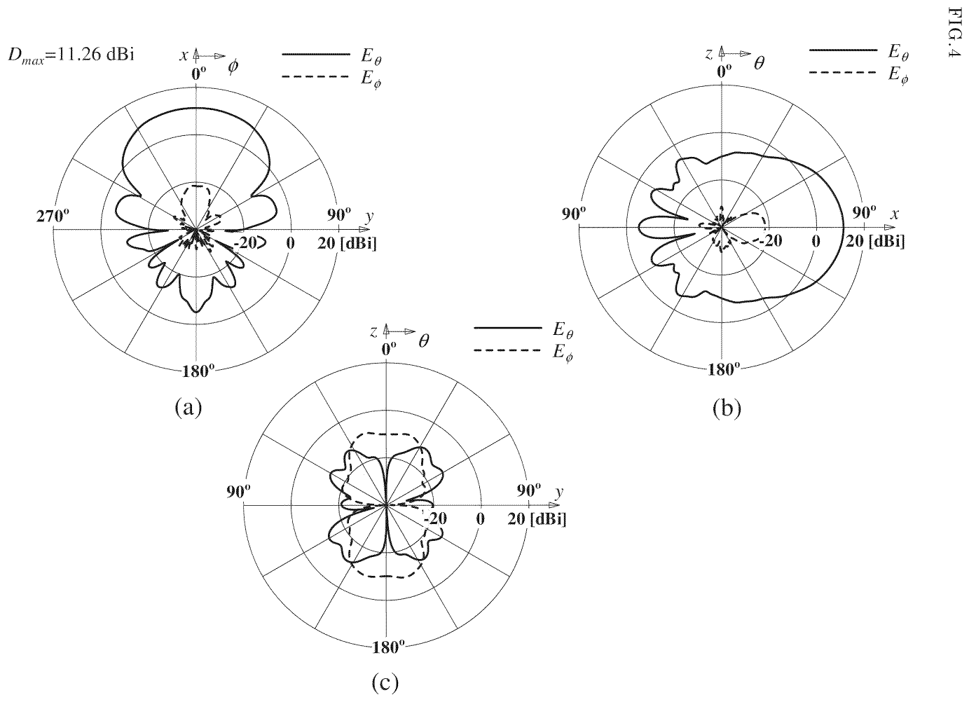

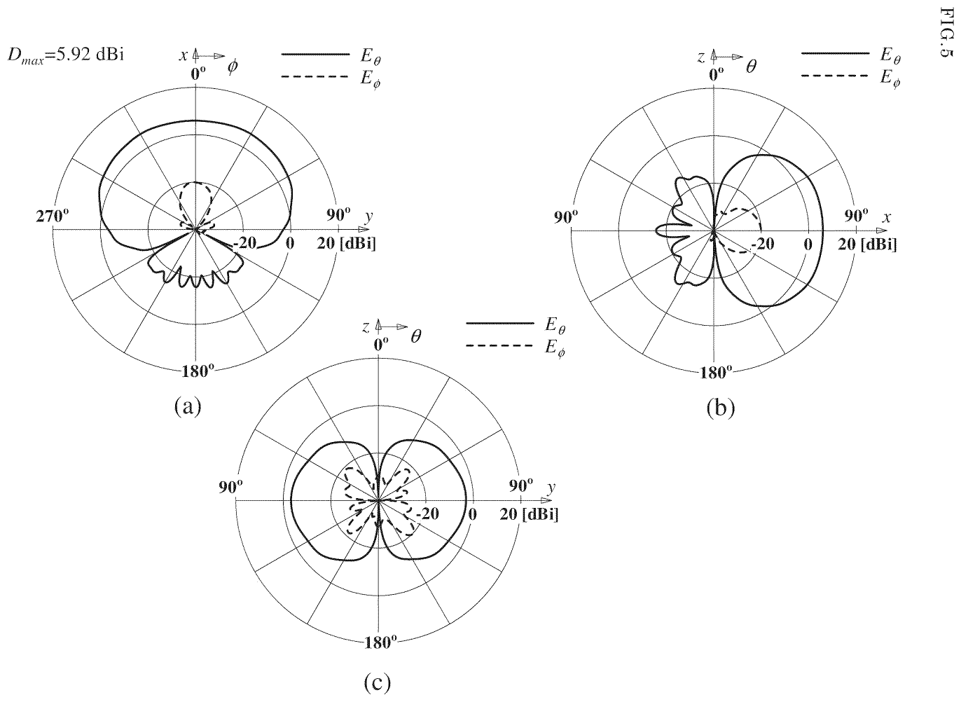

First, the directivity of the antenna device 10 shown in FIG. 1 in the xy plane (horizontal plane), xz plane (vertical plane), and yz plane (vertical plane) were obtained and are shown in FIGS. 4(a) to 4(c), respectively. For comparison, the directivity of the antenna device 10 in the xy plane (horizontal plane), xz plane (vertical plane), and yz plane (vertical plane) were also obtained for the case where there is no cover component 12 (comparative example), and are shown in FIGS. 5(a) to 5(c), respectively. Note that the antenna element 13 is a crossed-dipole antenna, and E, and E_{θ} in each figure indicate the directivity of the horizontally polarized waves and the vertically polarized waves, respectively.

Focusing on the vertically polarized waves E_{θ} in FIG. 4(a) and FIG. 5(a), it was confirmed that the maximum gain Dₘₐₓ was obtained at 0 degrees. It was also confirmed that the maximum gain of the vertically polarized waves E_{θ} of the antenna device 10 in FIG. 4(a) was about 5 dB larger than that of the comparative example in FIG. 5(a). It was also confirmed that the beam width of the vertically polarized waves E_{θ} of the antenna device 10 in FIG. 4(a) was slightly narrower than that of the comparative example in FIG. 5(a).

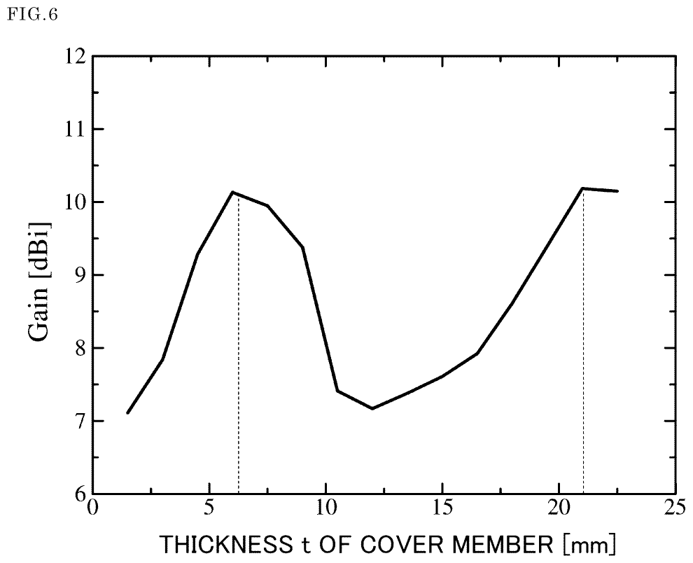

Next, the change in gain was obtained when the thickness t of the cover component 12 was changed for the antenna device 10 shown in FIG. 1. The gain to be obtained was the maximum gain of the vertically polarized waves E_{θ} in the xy plane (horizontal plane) (gain at θ=90°, φ=0°). The change in gain (Gain) with respect to the thickness t of the cover component 12 is shown in FIG. 6. As shown in FIG. 6, it was confirmed that the gain was high near t=7.5 mm and t=22.5 mm. Here, since λg≈28.6 mm, it can be said that the gain improvement effect is high when t is (2q−1)×λg/4 (where q=1, 2, 3, and so on).

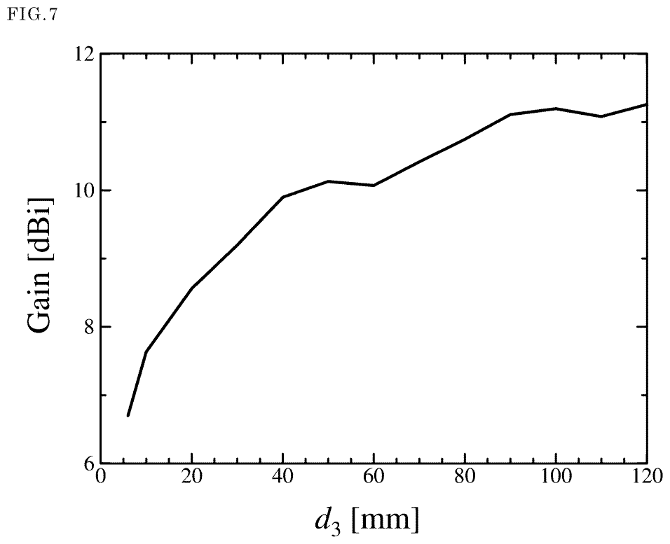

Next, the change in gain was obtained when the radius d₃ of the ground component 11 was changed for the antenna device 10 shown in FIG. 1. The gain to be obtained was the maximum gain of vertically polarized waves E_{θ} in the xy plane (horizontal plane) (gain at θ=90°, φ=0°). The change in gain (Gain) with respect to the radius d₃ of the ground component 11 is shown in FIG. 7. As shown in FIG. 7, it was confirmed that the gain increased as d₃ increased.

### Example 2

The directivity in the horizontal and vertical planes were obtained for the antenna device 10 having three antenna elements 13 shown in FIG. 2. Here, the frequency used was 5 GHz, the radius of the ground component 11 was d₃=8 mm, and the relative permittivity of the cover component 12 was 4.4. As a result, λ₀=60 mm, and λg≈28.6 mm.

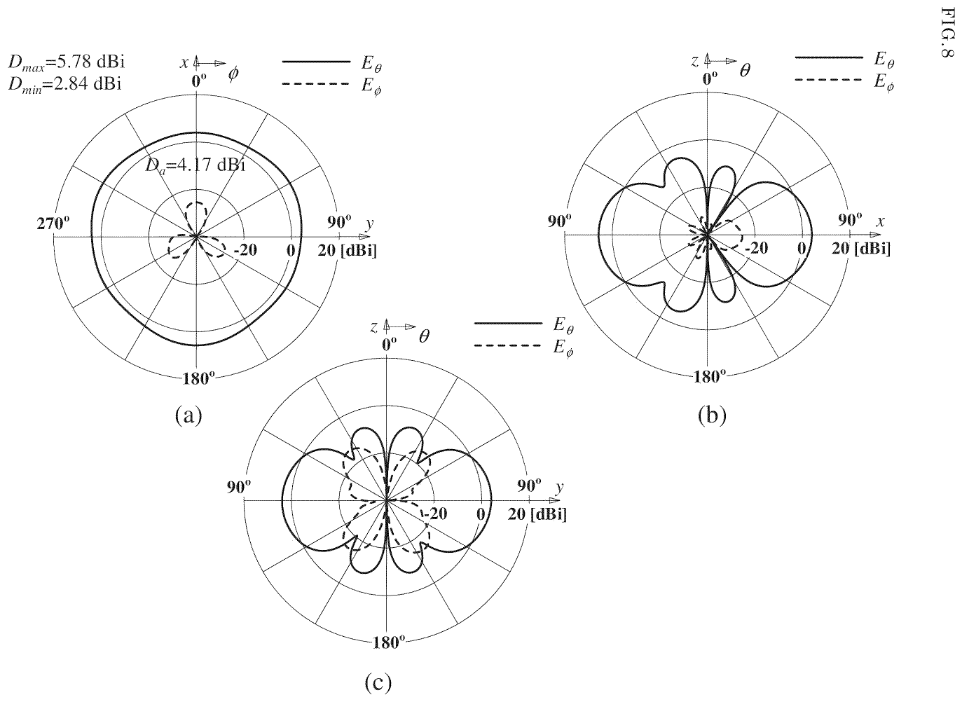

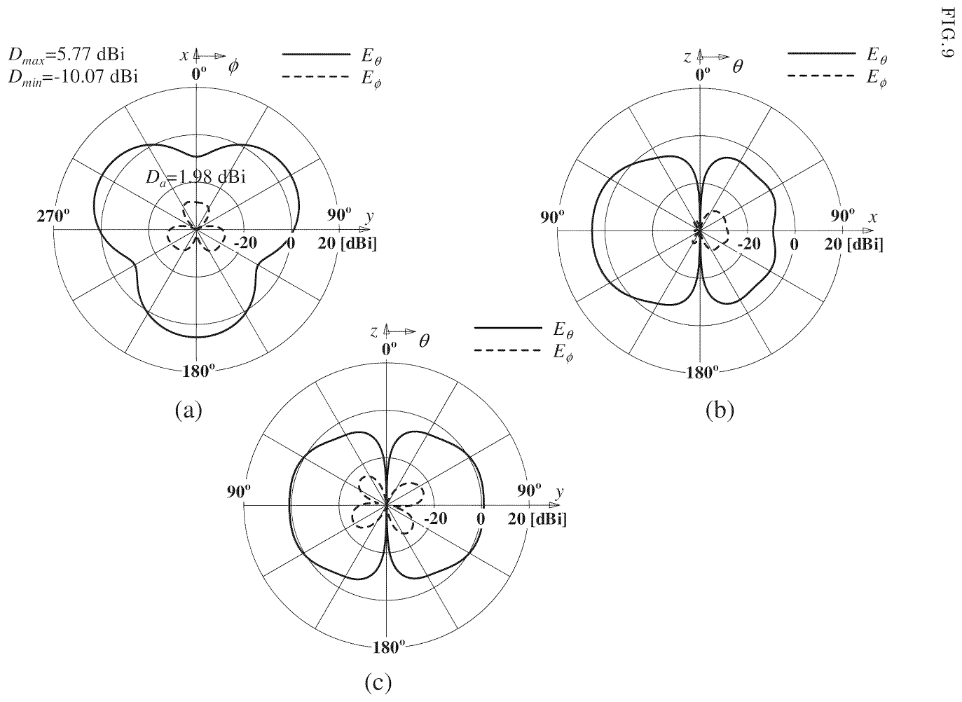

The directivity in the xy plane (horizontal plane), xz plane (vertical plane), and yz plane (vertical plane) of the antenna device 10 shown in FIG. 2 were obtained and are shown in FIGS. 8(a) to 8(c), respectively. For comparison, the directivity in the xy plane (horizontal plane), xz plane (vertical plane), and yz plane (vertical plane) were also obtained for the case where there is no cover component 12 (comparative example), and are shown in FIGS. 9(a) to 9(c), respectively. Note that the antenna element 13 is a crossed-dipole antenna, and E, and E_{θ} in each figure indicate the directivity of horizontally polarized waves and vertically polarized waves, respectively.

Focusing on the vertically polarized waves E_{θ} in FIGS. 8(a) and 9(a), it was confirmed that the maximum gain Dₘₐₓ was obtained at 60 degrees, 180 degrees, and 300 degrees, corresponding to the positions of the antenna elements 13. It was also confirmed that the average gain of vertically polarized waves E_{θ} in the antenna device 10 in FIG. 8(a) was about 2 dB larger than that in the comparative example in FIG. 9(a). It was also confirmed that the magnitude of deviation (roundness) of the gain of vertically polarized waves E_{θ} in FIG. 8(a) from a circular shape was within 3 dB and that the deviation from a circular shape was much smaller than that in the comparative example in FIG. 9(a). From this result, it can be said that the antenna device 10 in FIG. 8(a) achieves excellent omnidirectional property in the horizontal plane.

### Example 3

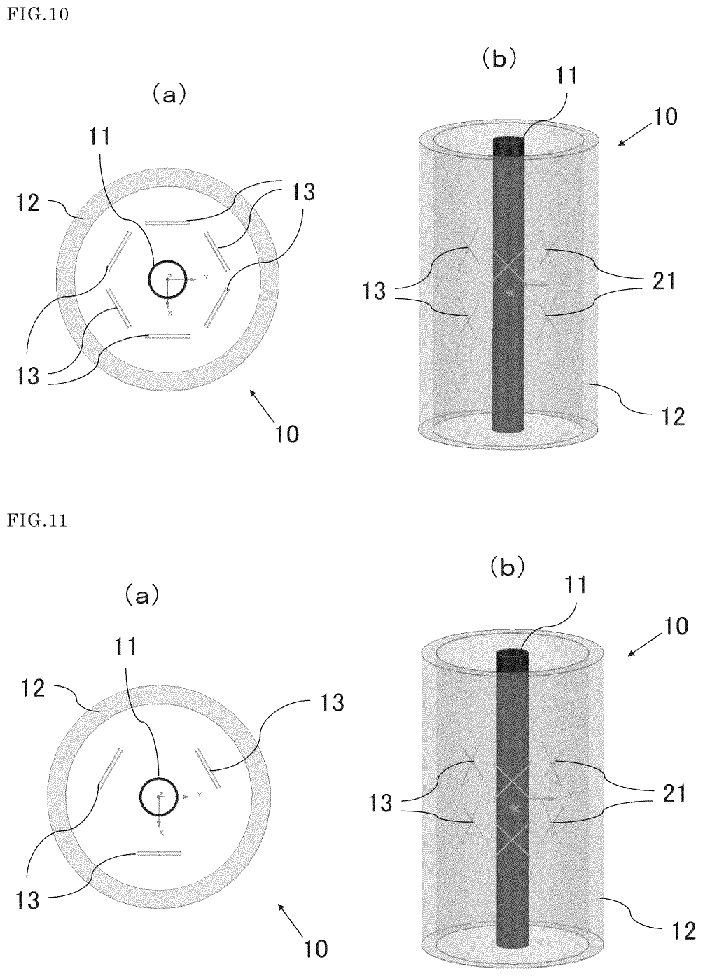

The directivity in the horizontal plane were obtained for the antenna device 10 with two element groups 21 and three antenna elements 13 in each element group 21. Here, the directivity in the horizontal plane were obtained for the antenna device 10 in which the positions of the antenna elements 13 of adjacent element groups 21 were shifted by rotating them by 60 degrees around the central axis of the ground component 11 as shown in FIG. 10, and the antenna device 10 in which the antenna elements 13 of each element group 21 were arranged at the same position in the circumferential direction of the central axis of the ground component 11 as shown in FIG. 11. The interval h between each element group 21 was 30 mm, the frequency used was 5 GHZ, the radius of the ground component 11 was d₃=8 mm, and the relative permittivity of the cover component 12 was 4.4. As a result, λ₀=60 mm, and λg≈28.6 mm.

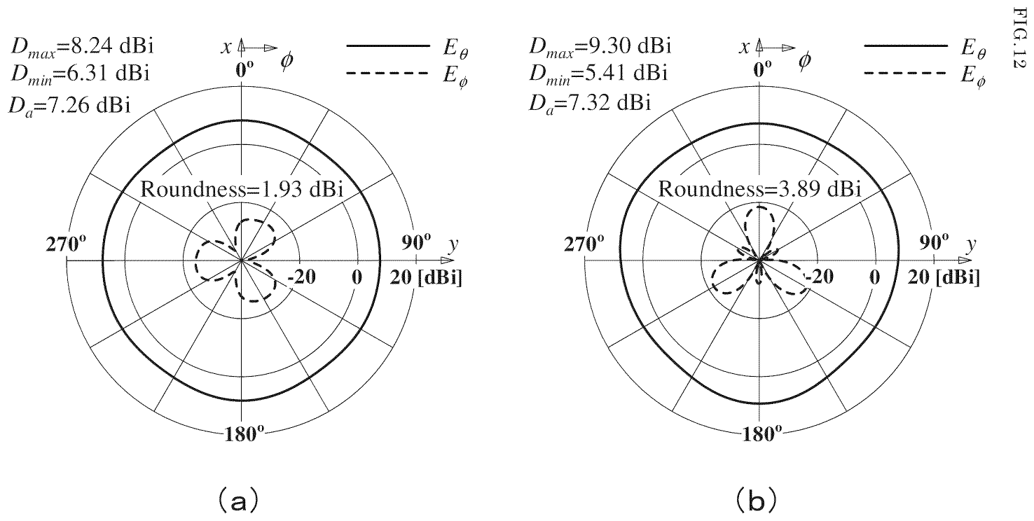

The directivity in the xy plane (horizontal plane) of the antenna devices 10 shown in FIG. 10 and FIG. 11 were obtained and are shown in FIGS. 12(a) and 12(b), respectively. Note that the antenna elements 13 are crossed-dipole antennas, and Ep and E_{θ} in each figure indicate the directivity of horizontally polarized waves and vertically polarized waves, respectively.

As shown in FIG. 12(a), it was confirmed that the maximum gain Dₘₐₓ was obtained at 0 degrees and 180 degrees for the vertically polarized waves E_{θ} of the antenna device 10 of FIG. 10. In contrast, as shown in FIG. 12(b), it was confirmed that the maximum gain Dₘₐₓ was obtained at 60 degrees, 180 degrees, and 300 degrees for the vertically polarized waves E_{θ} of the antenna device 10 of FIG. 11. In addition, the magnitude of deviation (roundness) from a circular shape of the gain of the vertically polarized waves E_{θ} of the antenna device 10 of FIG. 10 was about 2 dB, whereas the magnitude of deviation (roundness) from a circular shape of the gain of the vertically polarized waves E_{θ} of the antenna device 10 of FIG. 11 was about 4 dB, and it was confirmed that the magnitude of deviation from a circular shape of the antenna device 10 of FIG. 10 was smaller than that of the antenna device 10 of FIG. 11. It was also confirmed that the average gain Dₐ of the vertically polarized waves E_{θ} of the antenna devices 10 of FIG. 10 and FIG. 11 was approximately the same. From these results, it can be said that in the antenna device 10 having a plurality of element groups 21, better omnidirectional property in the horizontal plane could be obtained by arranging the antenna elements 13 of adjacent element groups 21 in a shifted manner around the central axis of the ground component 11.

### Example 4

For the antenna device 10 having a plurality of element groups 21 as shown in FIGS. 3(a), 3(b), and 3(d), the relationship between the number of element groups 21, the interval h between the element groups 21, and the average gain was obtained from the directivity of vertically polarized waves E_{θ} in the horizontal plane. Here, the number of antenna elements 13 in each element group 21 was three, and the positions of the antenna elements 13 of adjacent element groups 21 were rotated 60 degrees around the central axis of the ground component 11 and shifted. In addition, the frequency used was 5 GHz, the radius of the ground component 11 was d₃=8 mm, and the relative permittivity of the cover component 12 was 4.4. As a result, λ₀=60 mm, and λg≈28.6 mm.

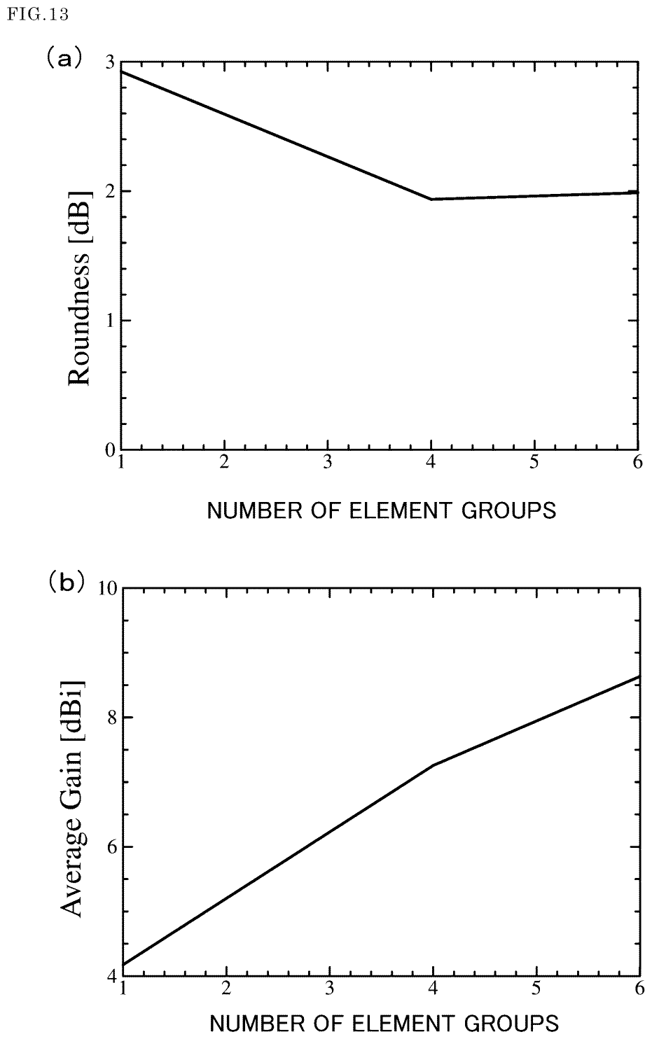

For the antenna element 13 shown in FIG. 3, the magnitude of deviation (roundness) of the gain of vertically polarized waves E_{θ} from a circular shape with respect to the number of element groups 21 when the interval h between the element groups 21 was 30 mm is shown in FIG. 13(a). As shown in FIG. 13(a), it was confirmed that the roundness was 3 dB or less, and decreased to about 2 dB as the number of element groups 21 increased. From this result, it can be said that the omnidirectional property in the horizontal plane is improved by increasing the number of element groups 21.

The change in average gain with respect to the number of element groups 21 at this time is shown in FIG. 13(b). As shown in FIG. 13(b), it was confirmed that the average gain increased as the number of element groups 21 increased.

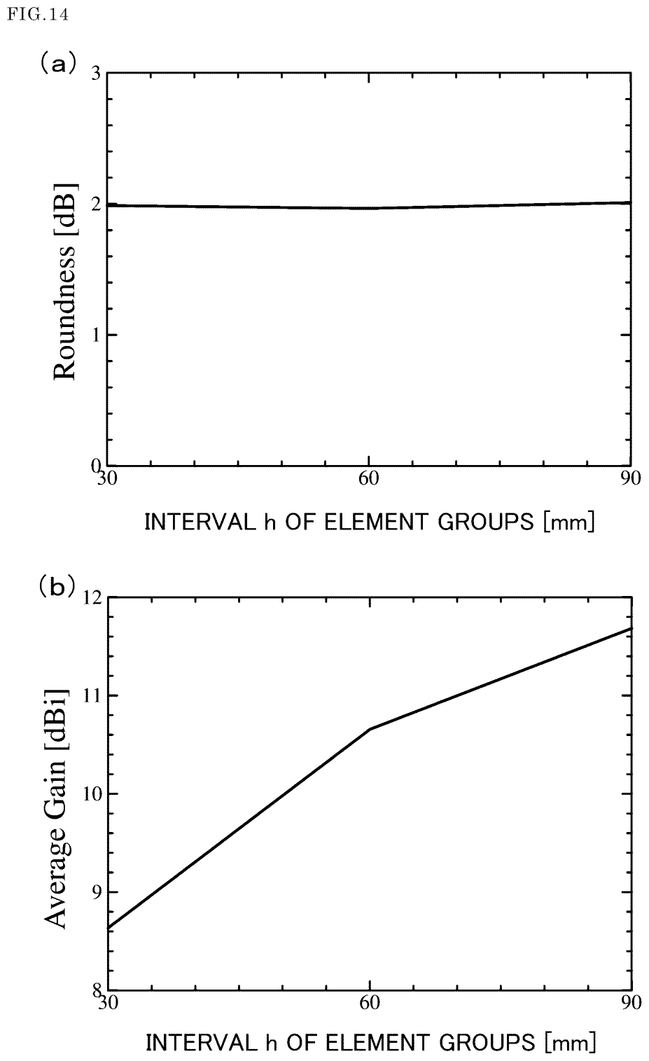

Next, the magnitude of deviation (roundness) of the gain of vertically polarized waves E_{θ} from a circular shape with respect to the interval h of the element groups 21 when the number of element groups 21 was six is shown in FIG. 14(a). As shown in FIG. 14(a), the roundness is reduced to about 2 dB regardless of the interval h of the element groups 21, and it can be said that excellent omnidirectional property in the horizontal plane is achieved.

The change in average gain with respect to the interval h of the element groups 21 in this case is shown in FIG. 14(b). As shown in FIG. 14(b), it was confirmed that the average gain increased as the interval h of the element groups 21 increased.

### REFERENCE SIGNS LIST

10 Antenna device
11 Ground component
12 Cover component
13 Antenna element
21 Element group

1. An antenna device comprising:
a ground component made of a columnar or cylindrical conductor and connected to a ground potential;
a cover component made of a material containing dielectrics, having a cylindrical shape, into which the ground component is inserted, the cover component being arranged at a distance from the ground component so as to cover an outer surface of the ground component; and
an antenna element arranged between an inner surface of the cover component and the outer surface of the ground component.

2. The antenna device according to claim 1, wherein
the antenna element is made up of a plurality of antenna elements which are arranged at equal angular intervals around a central axis of the ground component.

3. The antenna device according to claim 1, further comprising:
an element group made up of a plurality of antenna elements, in which the antenna elements are arranged at equal angular intervals around a central axis of the ground component, wherein
the element group is made up of a plurality of element groups which are arranged side by side at predetermined intervals along the central axis of the ground component.

4. The antenna device according to claim 3, wherein
each antenna element of each element group is arranged at a shifted position around the central axis of the ground component with respect to a position of each antenna element of an adjacent element group.

5. The antenna device according to claim 1, wherein
the cover component is arranged coaxially with the ground component, and
m×0.4×λ₀≤a≤m×0.6×λ₀ is satisfied where λ₀ is the wavelength of a used frequency in free space, a is a distance between the inner surface of the cover component and the outer surface of the ground component, and m=1, 2, 3, and so on.

6. The antenna device according to claim 5, wherein
each antenna element is arranged within a range of (2n−4/3)×λ₀/4 to (2n−2/3)×λ₀/4, where n=1, 2, 3, and so on, from the outer surface of the ground component.

7. The antenna device according to claim 1, wherein
a thickness t of the cover component is (2q−4/3)×λ_{g}/4≤t≤(2q−2/3)×λg/4, where λg is the wavelength of a used frequency in the cover component and q=1, 2, 3, and so on.

8. The antenna device according to claim 2, wherein
the cover component is arranged coaxially with the ground component, and
m×0.4×λ₀≤a≤m×0.6×λ₀ is satisfied where λ₀ is the wavelength of a used frequency in free space, a is a distance between the inner surface of the cover component and the outer surface of the ground component, and m=1, 2, 3, and so on.

9. The antenna device according to claim 3, wherein
the cover component is arranged coaxially with the ground component, and
m×0.4×λ₀≤a≤m×0.6×λ₀ is satisfied where λ₀ is the wavelength of a used frequency in free space, a is a distance between the inner surface of the cover component and the outer surface of the ground component, and m=1, 2, 3, and so on.

10. The antenna device according to claim 4, wherein
the cover component is arranged coaxially with the ground component, and
m×0.4×λ₀≤a≤m×0.6×λ₀ is satisfied where λ₀ is the wavelength of a used frequency in free space, a is a distance between the inner surface of the cover component and the outer surface of the ground component, and m=1, 2, 3, and so on.

11. The antenna device according to claim 2, wherein
a thickness t of the cover component is (2q−4/3)×λg/4≤t≤(2q−2/3)×λg/4, where λg is the wavelength of a used frequency in the cover component and q=1, 2, 3, and so on.

12. The antenna device according to claim 3, wherein
a thickness t of the cover component is (2q−4/3)×λg/4≤t≤(2q−2/3)×λg/4, where λg is the wavelength of a used frequency in the cover component and q=1, 2, 3, and so on.

13. The antenna device according to claim 4, wherein
a thickness t of the cover component is (2q−4/3)×λg/4≤t≤(2q−2/3)×λg/4, where λg is the wavelength of a used frequency in the cover component and q=1, 2, 3, and so on.

14. The antenna device according to claim 8, wherein
each antenna element is arranged within a range of (2n−4/3)×λ₀/4 to (2n−2/3)×λ₀/4, where n=1, 2, 3, and so on, from the outer surface of the ground component.

15. The antenna device according to claim 9, wherein
each antenna element is arranged within a range of (2n−4/3)×λ₀/4 to (2n−2/3)×λ₀/4, where n=1, 2, 3, and so on, from the outer surface of the ground component.

16. The antenna device according to claim 10, wherein
each antenna element is arranged within a range of (2n−4/3)×λ₀/4 to (2n−2/3)×λ₀/4, where n=1, 2, 3, and so on, from the outer surface of the ground component.
